(19) United States
(12) Patent Application Publication
(10) Pub. No.: US 2026/0138739 A1
(43) Pub. Date: May 21, 2026

(54) HIGH-SPEED VERTICAL TAKE-OFF AND LANDING AIRCRAFT

(71) Applicants: The Texas A&M University System, College Station, TX (US); Oklahoma State University, Stillwater, OK (US)

(72) Inventors: Moble Benedict, College Station, TX (US); David Allen Coleman, College Station, TX (US); Atanu Halder, Stillwater, OK (US)

(73) Assignees: The Texas A&M University System, College Station, TX (US); Oklahoma State University, Stillwater, OK (US)

(21) Appl. No.: 19/390,113

(22) Filed: Nov. 14, 2025

Related U.S. Application Data
(60) Provisional application No. 63/720,839, filed on Nov. 15, 2024.

(51) Int. Cl. B64C 29/00; B64C 3/40; B64C 27/24

(52) U.S. Cl. CPC B64C 29/0016; B64C 3/40; B64C 27/24

(57) ABSTRACT

A high-speed vertical take-off and landing (HSVTOL) aircraft includes an airframe, a pair of inner wings coupled to and extending from the airframe, and a pair of wing rotors pivotably coupled to the pair of inner wings, wherein each of the pair of wing rotor has a rotatable configuration in which the wing rotor is freely rotatable entirely about a rotational axis of the wing rotor to generate vertically directed thrust that is applied to the airframe in a vertical take-off and landing (VTOL) mode of the HSVTOL aircraft, and a fixed configuration in which the wing rotor is locked into a defined angular orientation about the rotational axis in a forward cruise mode of the HSVTOL aircraft.

### CROSS-REFERENCE TO RELATED APPLICATIONS

Not applicable. This application is a non-provisional application claiming priority to U.S. provisional Ser. No. 63/720,839 filed Nov. 15, 2024, and entitled “High-Speed Vertical Take-Off and Landing Aircraft,” which is hereby incorporated herein by reference in its entirety for all purposes.

### STATEMENT REGARDING FEDERALLY SPONSORED RESEARCH OR DEVELOPMENT

Not applicable.

### BACKGROUND

Vertical Take-Off and Landing (VTOL) aircraft are aircraft capable of taking off, hovering, and landing vertically without the need for runways and thus are capable of operating in environments inhospitable to conventional fixed wing aircraft dependent on runways for taking-off and landing. Classically, helicopters emerged as the primary form of VTOL aircraft; however, alternative forms of VTOL aircraft have utilized thrust vectoring technology to provide fixed wing aircraft with VTOL capabilities in order to address the limited forward speed and operational ranges of conventional helicopters. For instance, thrust vectoring fixed wing aircraft may incorporate a tiltrotor propeller that rotates between a vertical orientation for VTOL flight and a forward orientation for forward flight. Alternatively, thrust vectoring fixed wing aircraft may include a jet engine (e.g., a turbofan engine) having a pivotable nozzle for directing the thrust generated by the jet engine from a vertical orientation for VTOL flight and a horizontal orientation for forward flight.

### BRIEF SUMMARY

An embodiment of a high-speed vertical take-off and landing (HSVTOL) aircraft comprises an airframe, a pair of inner wings coupled to and extending from the airframe, and a pair of wing rotors pivotably coupled to the pair of inner wings, wherein each of the pair of wing rotor has a rotatable configuration in which the wing rotor is freely rotatable entirely about a rotational axis of the wing rotor to generate vertically directed thrust that is applied to the airframe in a vertical take-off and landing (VTOL) mode of the HSVTOL aircraft, and a fixed configuration in which the wing rotor is locked into a defined angular orientation about the rotational axis in a forward cruise mode of the HSVTOL aircraft. In some embodiments, the pair of wing rotors form at least a portion of a pair of fixed wings of the HSVTOL aircraft when in the forward cruise mode. In some embodiments, the HSVTOL aircraft includes a high-speed configuration when in the forward cruise mode in which the pair of wing rotors have a first sweep angle, and a low-speed configuration when in the forward cruise mode in which the pair of wing rotors have a second sweep angle that is different from the first sweep angle. In certain embodiments, a sweep angle of the pair of wing rotors is adjustable when the HSVTOL aircraft is in the forward cruise mode. In certain embodiments, the HSVTOL aircraft comprises a locking member having an unlocked state permitting the free rotation of one or both of the pair of wing rotors about their rotational axes, and a locked state restricting rotation of one or both of the pair of wing rotors about their rotational axes. In some embodiments, the HSVTOL aircraft comprises a prime mover separate from the pair of wing rotors and configured to drive rotation of one or both of the pair of wing rotors when the HSVTOL aircraft is in the VTOL mode. In some embodiments, the prime mover comprises a jet engine and at least one of the pair of wing rotors comprises a nozzle configured to receive a fluid flow from the jet engine to rotate the rotor about the rotational axis. In certain embodiments, one or both of the pair of wing rotors comprises a single blade and a counterweight located diametrically opposite the single blade. In certain embodiments, the pair of wing rotors each comprises an electric, ducted fan positioned at a tip thereof and a battery located opposite the fan to act as a counterweight. In some embodiments, the HSVTOL aircraft comprises a pair of rotary actuators coupled to the airframe for driving the rotation of the pair of wing rotors about their rotational axes.

An embodiment of a HSVTOL aircraft comprises an airframe, one or more prime movers coupled to the airframe and operable to generate forward thrust that is applied to the airframe during operation of the HSVTOL aircraft, a pair of inner wings coupled to and extending from the airframe, and a pair of wing rotors pivotably coupled to the pair of inner wings and powerable by the one or more prime movers to rotate each about a rotational axis of the wing rotor to generate a vertically directed thrust that is applied to the airframe during operation of the HSVTOL aircraft and which is separate from the forward thrust generated by the prime mover, and wherein both of the pair of wing rotors are lockable to the airframe during operation of the HSVTOL aircraft to restrict rotation of the rotor relative to the airframe. In some embodiments, the one or more prime movers comprises a jet engine and at least one of the pair of wing rotors comprises a nozzle configured to receive a fluid flow from the jet engine to rotate the wing rotor about the rotational axis. In certain embodiments, the fluid flow comprises combustion products from the jet engine. In certain embodiments, the one or more prime movers comprises a jet engine and at least one of the pair of wing rotors comprises a tip jet configured to receive a fluid flow from the jet engine to rotate the wing rotor about the rotational axis. In some embodiments, the HSVTOL aircraft comprises a pair of rotary actuators coupled to the airframe for driving the rotation of the pair of wing rotors about their rotational axes.

An embodiment of a HSVTOL aircraft comprises an airframe, a pair of inner wings coupled to and extending from the airframe, and a pair of wing rotors pivotably coupled to the pair of inner wings and each rotatable about a rotational axis of the wing rotor to generate a vertically directed thrust that is applied to the airframe during operation of the HSVTOL aircraft, and wherein the pair of wing rotors are lockable to the airframe in a forward cruise mode of the HSVTOL aircraft to provide lift to generate lift. In some embodiments, the rotational axis of both of the pair of wing rotors remains fixed in orientation when the HSVTOL is in both the forward cruise mode and a vertical take-off and landing (VTOL) mode. In certain embodiments, the HSVTOL aircraft comprises a plurality of the pairs of wing rotors each rotatable about a separate rotational axis. In certain embodiments, a first pair of the plurality pairs of wing rotors is vertically offset from a second pair of the plurality of pairs of wing rotors. In some embodiments, the HSVTOL aircraft comprises a fixed wing extending from the airframe and having a terminal end defined by a terminal end of one of the pair of wing rotors. In some embodiments, the rotational axis of the one of the pair of wing rotors extends through both the wing rotor and the fixed wing. In certain embodiments, at least one of the pair of wing rotors comprises an electric, ducted fan positioned at a tip thereof and a battery located opposite the fan to act as a counterweight. In certain embodiments, the HSVTOL aircraft comprises a pair of rotary actuators coupled to the airframe for driving the rotation of the pair of wing rotors about their rotational axes.

### BRIEF DESCRIPTION OF THE DRAWINGS

For a detailed description of disclosed embodiments, reference will now be made to the accompanying drawings in which:

FIGS. 1-4 are schematic top views of high-speed vertical takeoff and landing (HSVTOL) aircraft according to some embodiments;

FIG. 5 is a perspective view of another HSVTOL aircraft according to some embodiments;

FIG. 6 is a side view of the HSVTOL aircraft of FIG. 5;

FIG. 7 is a front view of the HSVTOL aircraft of FIG. 5;

FIGS. 8 and 9 are top views of the HSVTOL aircraft of FIG. 5;

FIG. 10 is a bottom view of the HSVTOL aircraft of FIG. 5;

FIG. 11 is a graph depicting power as a function of speed according to some embodiments;

FIG. 12 is a graph depicting lift to drag ratio as a function of speed according to some embodiments;

FIG. 13 is a perspective view of the HSVTOL aircraft of FIG. 5. Along with an exemplary payload according to some embodiments; and

FIG. 14 is a block diagram of a computer system according to some embodiments.

### DETAILED DESCRIPTION OF DISCLOSED EMBODIMENTS

The following discussion is directed to various embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . .” Also, the term “couple” or “couples” is intended to mean either an indirect or direct connection. Thus, if a first device couples to a second device, that connection may be through a direct connection, or through an indirect connection as accomplished via other devices, components, and connections. In addition, as used herein, the terms “axial” and “axially” generally mean along or parallel to a central axis (for example, central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

As described previously, alternative forms of VTOL aircraft have utilized thrust vectoring technology to provide fixed wing aircraft with VTOL capabilities in order to address the limited forward speed and operational ranges of conventional helicopters. For instance, thrust vectoring fixed wing aircraft may incorporate a tiltrotor propeller that rotates between a vertical orientation for VTOL flight and a forward orientation for forward flight. Alternatively, thrust vectoring fixed wing aircraft may include a jet engine (e.g., a turbofan engine) having a pivotable nozzle for directing the thrust generated by the jet engine from a vertical orientation for VTOL flight and a horizontal orientation for forward flight

While existing thrust vectoring aircraft partially address some of the limitations of conventional helicopters, such as the relatively poor forward flight performance of conventional helicopters relative to fixed wing aircraft, such thrust vectoring aircraft still suffers from limitations that limit their performance in VTOL and/or forward flight. For example, the engines of existing thrust vectoring aircraft typically have a relatively small disk area compared to conventional helicopters, reducing their efficiency in VTOL flight relative to conventional helicopters which are provided with a greater disk area (e.g., defined by the diameter of the rotors of the helicopter in some instances) with which to efficiently generate vertical thrust. Additionally, existing thrust vectoring aircraft may suffer from relatively poor forward flight performance relative to conventional fixed wing aircraft due to relatively greater drag and increased weight associated with the equipment (e.g., tilting mechanisms and other related equipment) required for facilitating the vectoring of thrust produced by the engine of the thrust vectoring aircraft. Moreover, the increased mechanical complexity of such existing thrust vectoring aircraft reduce their reliability relative to conventional fixed wing aircraft.

Accordingly, embodiments of High-Speed VTOL (HSVTOL) aircraft are described herein that overcome of at least some of the limitations of both conventional VTOL aircraft like helicopters and more recent technologies such as thrust vectoring fixed wing aircraft. Particularly, in some embodiments, the HSVTOL aircraft includes a rotor having a rotatable configuration in which the rotor may rotate about a rotational axis thereof to generate vertical thrust when the HSVTOL aircraft is in a VTOL state, and a fixed configuration in which the rotor remains generally fixed relative to the rotational axis when the HSVTOL aircraft is in a forward cruise state. In some embodiments, rotation of the rotor about the rotational axis may be self-driven by a dedicated motor (e.g., an electric motor) of the rotor whereas in other embodiments rotation of the rotor may be driven by a separate engine of the HSVTOL aircraft configured to generate forward thrust for the HSVTOL aircraft when the HSVTOL aircraft is in both the VTOL and forward cruise states.

As an example, in certain embodiments, the HSVTOL aircraft comprises one or more jet engines (e.g., turbofan engines) fluidically connected to the rotor for driving rotation of the rotor about the rotational axis. For instance, a portion of the airflow passing through the jet engine may be redirected to the rotor such as a tip jet or a nozzle thereof for driving rotation of the rotor. This airflow may be ejected by the nozzle of the rotor or, alternatively, combusted by a tip jet of the rotor to drive rotation. As a further alternative, a portion of the combustion products generated by the jet engine of the HSVTOL aircraft may be redirected to the rotor (e.g., a nozzle thereof) to drive rotation of the rotor. In certain embodiments, the rotor includes an electric, ducted fan positioned at the tip thereof and a battery located opposite the fan to act as a counterweight.

In certain embodiments, the rotor of the HSVTOL aircraft comprises a single rotor blade having a radially outer end defining an outer diameter of the rotor and a radially inner end to which a counterweight of the rotor is coupled. In some embodiments, a nozzle or tip jet may be coupled to the radially outer end of the single rotor blade for driving rotation of the rotor about the rotational axis. Additionally, in some embodiments, the HSVTOL aircraft may include a plurality of rotors with at least some of the rotors being vertically offset from at least another rotor of the HSVTOL aircraft in order to maximize the disk area of the rotors of the HSVTOL aircraft. For instance, the rotors may be coupled to terminal ends of one or more fixed wings of the HSVTOL aircraft such that the rotational axis of the rotor extends through both the rotor and the terminal end of the fixed wing. In this configuration, the rotor may form an outer portion of the fixed wing when the HSVTOL aircraft is in the forward cruise state. Moreover, a sweep of the rotor may be adjusted (e.g., increased when in a high-speed configuration and reduced when in a low-speed configuration) when HSVTOL aircraft is in the forward cruise state to maximize the forward flight performance of the HSVTOL aircraft across a range of speeds.

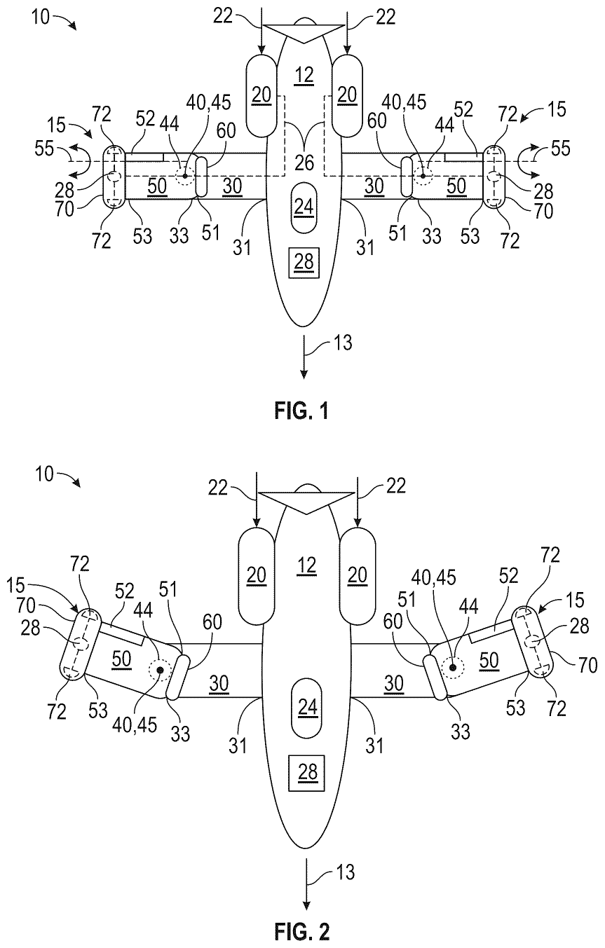

Referring now to FIG. 1, an embodiment of a HSVTOL aircraft 10 is shown. As will be discussed further herein, HSVTOL aircraft 10 is shiftable while airborne between a VTOL mode and a forward cruise mode shown in FIG. 1. The VTOL mode of HSVTOL aircraft 10 permits the HSVTOL aircraft 10 to hover above a selected surface location as well as vertically takeoff and land from selected surface locations. In some embodiments, the HSVTOL aircraft 10 may have similar hover power as a conventional helicopter when in the VTOL mode. Additionally, the forward cruise mode of HSVTOL aircraft 10 permits the HSVTOL aircraft 10 to travel forward at high speeds. In certain embodiments, the HSVTOL aircraft 10 may have a substantially greater lift to drag ratio in high-speed forward flight enabling the HSVTOL aircraft 10 to sustain high forward speeds at substantially lower power than conventional helicopters.

In this exemplary embodiment, HSVTOL aircraft 10 generally includes an airframe or fuselage 12, one or more forward prime movers 20 coupled to the airframe 12, a power source 24 coupled to the airframe 12, an onboard computer-implemented controller 28, a pair of inner wings 30 coupled to and extending from the airframe 12, and a pair of wing rotors 50 coupled to the pair of inner wings 30. The HSVTOL aircraft 10 may include additional equipment not shown in FIG. 1 in some embodiments.

While HSVTOL aircraft 10 is shown in FIG. 1 as including a pair of prime movers 20, in other embodiments, HSVTOL aircraft 10 may include a single prime mover 20 or more than two prime movers 20. In some embodiments, the prime movers 20 comprise internal combustion engines (ICEs) such as ICEs driving external propellers, jet engines (e.g., turbofans), and the like with power source 24 comprising an onboard fuel source 24 for powering the prime movers 20. In other embodiments, prime movers 20 comprise electrically powered motors and the like with power source 24 comprising one or more onboard batteries. Prime movers 20 generate forward thrust (indicated by arrows 22) to propel the HSVTOL aircraft 10 in a forward direction (indicated by arrow 13) in either the forward cruise mode or the VTOL mode of HSVTOL aircraft 10. Additionally, prime movers 20 may produce a high-speed output gas output during operation which may be used to generate forward thrust 22. Such high-speed gas may comprise combustion products produced by prime movers 20 in some embodiments. In this exemplary embodiment, a pair of fluid conduits 26 extend between the prime movers 20 and the pair of wing rotors 50 for selectably directing at least a portion of the output gas produced by prime movers 20 to the wing rotors 50 as will be discussed further herein.

The inner wings 30 of HSVTOL aircraft 10 provide vertical lift to the HSVTOL aircraft 10, particularly when HSVTOL aircraft 10 is in the forward cruise mode. While HSVTOL aircraft 10 is shown in FIG. 1 as including a single pair of inner wings 30 and a single pair of accompanying wing rotors 50, in other embodiments, HSVTOL 10 may comprise additional pairs of inner wings 30 and wing rotors 50. Each inner wing 30 extends longitudinally between a first end or base 31 coupled to the airframe 12 and an opposing second or terminal end 33 spaced from the airframe 12.

The wing rotors 50 of HSVTOL aircraft 10 may provide vertical lift to the HSVTOL aircraft 10 in the forward cruise mode passively as fixed-wings and actively as rotating rotors when HSVTOL aircraft 10 is in the VTOL mode. Each wing rotor 50 extends longitudinally between a first end or base 51 and an opposing second or terminal end 53. The base 51 of each wing rotor 50 is pivotably coupled by to the terminal end 33 of an accompanying inner wing 30 via a rotatory joint 40. In this exemplary embodiment, each rotary joint 40 comprises an actuatable locking member 44 (e.g., an electromechanical clutch and the like) shiftable between an unlocked state and a locked state. When locking member 44 is in the unlocked state, rotary joint 40 permits 360-degree free rotation of wing rotor 50 relative to inner wing 30 about a rotational axis 45 extending centrally through the rotary joint 40. However, when locking member 44 is in the locked state, relative rotation between the wing rotor 50 and the inner wing 30 about the rotational axis 45 is restricted. When HSVTOL aircraft 10 is in the forward cruise mode, each inner wing 30 and accompanying rotor wing 50 collectively defines a vertical lift generating fixed-wing 15 of the HSVTOL aircraft 10 extending between the base 31 of the inner wing 30 and the terminal end 51 of the wing rotor 50.

In this exemplary embodiment, each rotor wing 50 comprises an actuatable rotor flap 52 extending along a trailing edge of the rotor wing 50. Particularly, each rotor flap 52 is rotatable (in either rotational direction) about a flap axis 55 that extends generally parallel along the longitudinal axis of the rotor wing 50. In some embodiments, inner wings 30 may also comprise one or more actuatable flaps similar in configuration to rotor flaps 52. Additionally, in this exemplary embodiment, each rotor wing 50 comprises a counterweight 60 located at the base 51 and a tip jet 70 located at the terminal end 53 thereof. The counterweight 60 may balance the weight of wing rotor 50 when rotating about rotational axis 45.

Tip jets 70 drive the rotation of wing rotors 50 about rotational axes 45 when HSVTOL aircraft 10 is in the VTOL mode. In this exemplary embodiment, tip jets 70 include one or more nozzles 72 positioned along the leading edge and/or the trailing edge of rotor wing 50 and which are fluidically connected to the prime movers 20 via fluid conduits 26 for receiving at least a portion of the output gas produced by prime movers 20 when HSVTOL aircraft 10 is in the VTOL mode.

For instance, one or more valves 28 may be positioned along fluid conduits 26 and/or incorporated into tip jets 70 for controlling the flow of output gasses between prime movers 20. While each tip jet 70 of HSVTOL aircraft 10 is shown in FIG. 1 as comprising a nozzle 72 located along both the leading edge and the trailing edge of wing rotor 50, in other embodiments, each tip jet 70 may include only a single nozzle 72 (e.g., a single nozzle 72 located along the trailing edge of rotor wing 50). Nozzles 72 are generally configured to increase a velocity of an output gas discharged therefrom to maximize rotational thrust generated by the nozzle 72.

For example, valves 28 may control the amount or percentage of output gas produced by prime movers 20 that is diverted to tip jets 70 with this percentage ranging, in some embodiments, between 0% when HSVTOL aircraft 10 is in the forward cruise mode, and potentially 100% when HSVTOL aircraft 10 is in the VTOL mode. Additionally, valves 28 may divert a non-zero percentage of the output gas (less than 100%) produced by prime movers 20 to the tip jets 70 when in the forward cruise or VTOL modes, particularly when it is desired to shift between the forward cruise and VTOL modes.

In some embodiments, valves 28 may also control the amount of the diverted gas received by tip jets 70 from prime movers 20 directed to individual nozzles 72 of tip jets 70. For instance, valves 28 may direct a majority or 100% of the diverted gas received by tip jets 70 to the nozzles 72 located along the trailing edges of wing rotors 50 to drive the rotation of wing rotors 50 in first rotational directions about rotational axes 45. Conversely, valves 28 may direct a majority or 100% of the diverted gas received by tip jets 70 to the nozzles 72 located along the leading edges of wing rotors 50 to drive the rotation of wing rotors 50 in opposing second rotational directions about rotational axes 45. The amount of diverted output gas directed to the trailing and leading edge nozzles 72 of tip jets 70 (as well as the overall amount of diverted output gas provided to tip jets 70 from prime movers 20) may also be used to control the rotational speed of wing rotors 50 about rotational axes 45 in either the first or second rotational directions. In some embodiments, HSVTOL aircraft 10 may be provided with one or more actuatable braking mechanisms for, e.g., mechanically reducing the rotational speed of wing rotors 50 about rotational axes 45 in either the first or second rotational directions.

In some embodiments, tip jets 70 may comprise prime movers of their own, such as jet engines or other prime movers. For instance, in an embodiment, at least one of the tip jets 70 may comprise an electric, ducted fan with the counterweight 60 comprising one or more electrical batteries for powering the electric, ducted fan.

The onboard controller 28 may be in signal communication with the various actuatable or operable equipment of HSVTOL aircraft 10 including, for example, prime movers 20, valves 28, and rotor flaps 52. In some embodiments, onboard controller 28 may control the operable equipment of HSVTOL aircraft 10 in response to receiving command signals from an onboard or remotely located human of pilot HSVTOL aircraft 10. In other embodiments, onboard controller 28 may control the onboard equipment of HSVTOL aircraft 10 autonomously or semi-autonomously in accordance with instructions (e.g., in the form of a predefined operational plan or routine) stored in one or more memory devices of the onboard controller 28. In some embodiments, onboard controller 28 may comprise one or more wireless transceivers and/or one or more sensors to provide, for example, positional, heading, and/or speed information of the HSVTOL aircraft 10.

In some embodiments, HSVTOL aircraft 10 may not include tip jets 70 and the rotation of wing rotors 50 may instead be driven by one or more prime movers coupled directly to the airframe 12 and/or to the inner wings 30. For example, in some embodiments, locking members 44 may instead comprise rotary actuators driven by, for example, electric motors, for selectably rotating the wing rotors 50 about their rotational axes 45. Such rotary actuators or motors may be used in lieu of or in combination with tip jets 70 for driving the rotation of wing rotors 50 when HSVTOL aircraft 10 is in the VTOL mode.

Referring to FIGS. 1-4, additional views of the HSVTOL aircraft 10 are provided. In this exemplary embodiment, with HSVTOL aircraft 10 in the forward cruise mode, the fixed wings 15 of HSVTOL aircraft 10 include a plurality (e.g., two or more) of different sweep configurations for maximizing the performance of HSVTOL aircraft 10 at different forward speeds. For example, FIG. 1 shows HSVTOL aircraft 10 in a low speed configuration in which central axes of the wing rotors 50 extend parallel central axes of inner wings 30 for providing configuring fixed wings 15 to provide a maximal amount of vertical lift at a given forward speed of HSVTOL aircraft 10. FIG. 2 shows HSVTOL aircraft 10 in a high-speed configuration in which the wing rotors 50 are swept relative to the inner wings 30 such that central axes of wing rotors 50 extend at non-zero angles relative to central axes of inner wings 30. This high-speed configuration of fixed wings 15 may reduce the drag of HSVTOL aircraft 10 at high-speeds when it is unnecessary to maximize the vertical lift provided by fixed wings 15. The fixed wings 15 may shift between their different sweep configurations by briefly shifting locking members 44 to their unlocked states and/or in response to diverting an amount of output gas from prime movers 20 to tip jets 70 to selectably drive rotation of wing rotors 50 about rotational axes 45.

In some embodiments, tip jets 70 may not comprise their own combustion chambers for combusting ambient air received by the tip jets 70 and instead may generate thrust by ejecting output gasses diverted from prime movers 20. In this manner, the weight and complexity of tip jets 70 may be minimized, in-turn minimizing the weight and overall mechanical complexity of fixed wings 15. In other embodiments, tip jets 70 may instead comprise prime movers that are potentially not fluidically connected with prime movers 20 and instead may create their own rotational thrust via their independent operation (e.g., as jet engines, propellers, and the like).

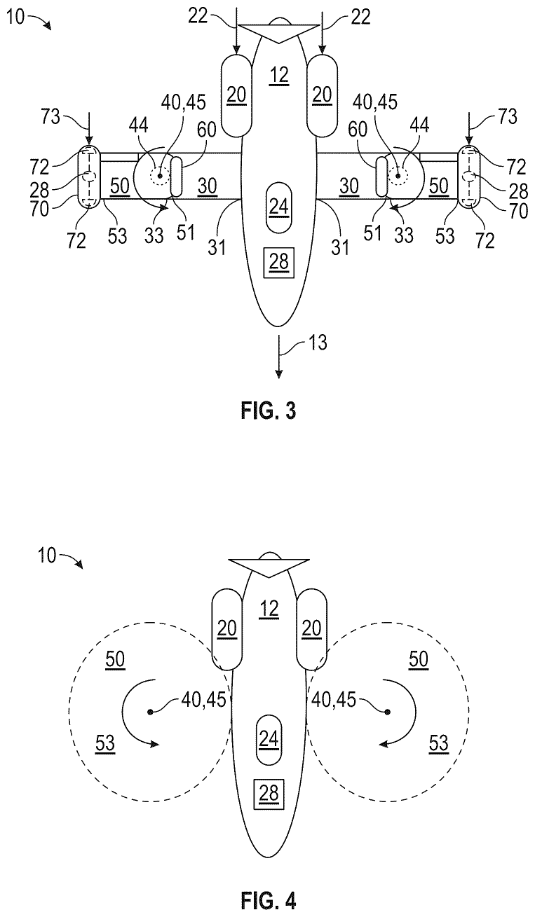

While FIGS. 1 and 2 illustrate HSVTOL aircraft 10 in the forward cruise mode, FIG. 3 illustrates HSVTOL aircraft 10 shifting from the forward cruise mode to the VTOL mode while FIG. 4 illustrates HSVTOL aircraft 10 in the VTOL mode. As shown particularly in FIG. 3, when transitioning HSVTOL aircraft 10 between the forward cruise and VTOL modes, and with locking members 44 in their unlocked states, at least a portion of the output gas produced by prime movers 20 is diverted to the tip jets 70 and ejected from at least one of the nozzles 72 of tip jets 70 to provide rotational thrust (indicated by arrows 73 in FIG. 3) to the wing rotors 50. By driving the tip jets 70 using output gasses provided by prime movers 20 used for forward cruise, the HSVTOL aircraft 10 provides separate means for providing forward thrust 22 directly from prime movers 20 along with rotational thrust 73 from tip jets 70 while avoiding having two separate powertrains, thereby significantly reducing the overall weight and mechanical complexity of HSVTOL aircraft 10.

As rotational thrust 73 is applied by tip jets 70 to rotor wings 50, rotor wings 50 begin to rotate continuously (360 degrees) about rotational axes 45 to actively generate vertical lift irrespective of the forward speed of HSVOL aircraft 10. Particularly, the vertical lift generated by the continuous rotation of rotor wings 50 about rotational axes 45 is a function of the magnitudes of the rotational speed of rotor wings 50 and the disk areas 53 (shown in FIG. 4) of rotor wings 50 defined by the longitudinal lengths of rotor wings 50 extending between ends 51 and 53. Additionally, the amount of vertical thrust (in either a vertically upwards or a downwards direction) may be controlled by adjusting the angle of rotor flaps 52 about flap axes 55. For instance, the flap angles of a rotor flap 52 may be increased in some embodiments to selectably increase a vertical thrust produced by a given wing rotor 50.

The percentage of output gas produced by prime movers 20 diverted to tip jets 70 may be gradually increased when shifting HSVOL aircraft 10 from the forward cruise mode to the VTOL mode whereby the amount of forward thrust 22 generated by prime movers 20 declines while the amount of rotational thrust 73 generated by tip jets 70 increases. In this manner, the amount of vertical lift driven by the rotation of wing rotors 50 about rotational axes 45 may be gradually increased as forward speed of HSVOL aircraft 10 declines. Conversely, the percentage of output gas produced by prime movers 20 diverted to tip jets 70 may be gradually reduced when shifting HSVOL aircraft 10 from the VTOL mode to the forward cruise mode whereby the amount of forward thrust 22 generated by prime movers 20 increases while the amount of rotational thrust 73 generated by tip jets 70 decreases. In this manner, the amount of vertical lift driven by the rotation of wing rotors 50 about rotational axes 45 may be gradually decreased as forward speed of HSVOL aircraft 10 increases with vertical lift instead being provided passively by inner wings 30 and wing rotors 50.

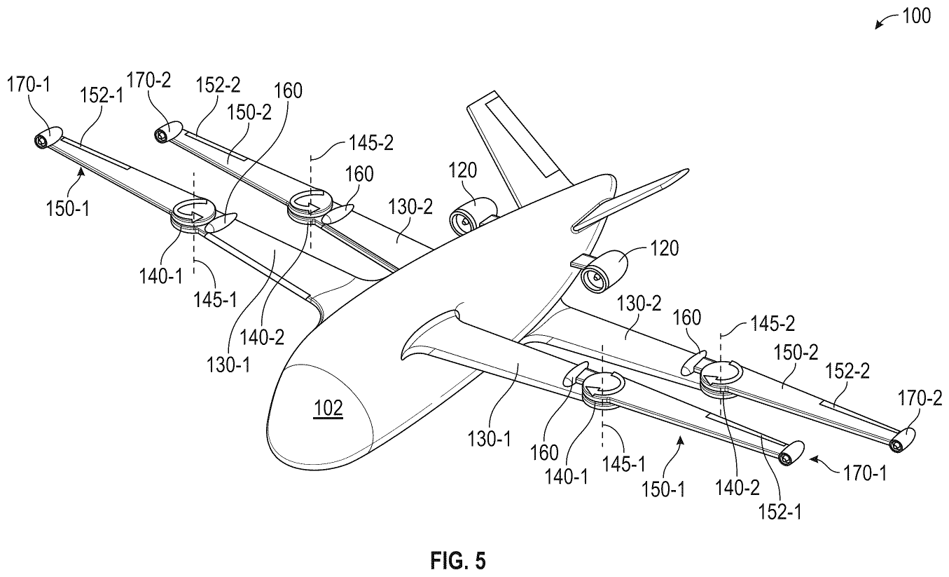

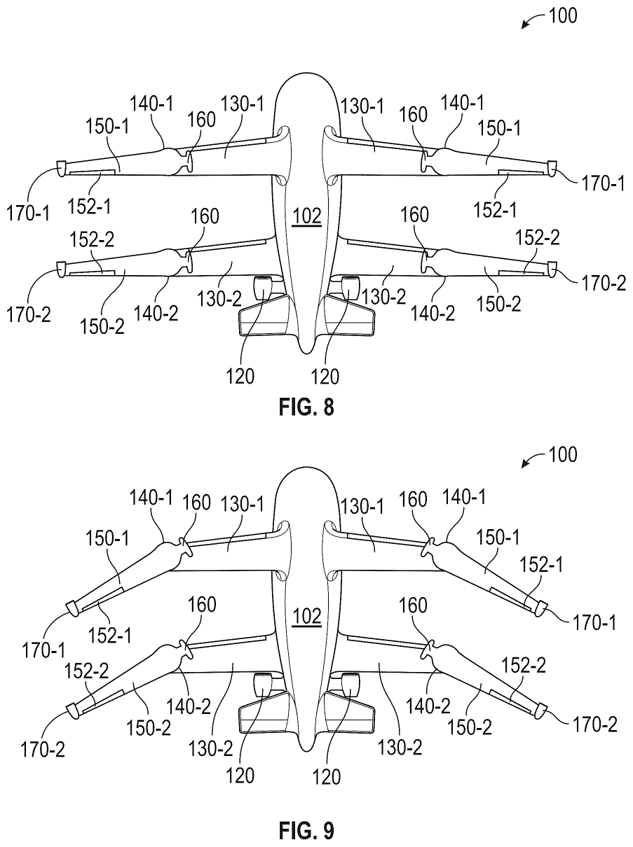

Referring to FIGS. 5-10, another embodiment of a HSVTOL aircraft 100 is shown. In this exemplary embodiment, HSVTOL aircraft 100 generally includes an airframe or fuselage 102, one or more forward prime movers 120 coupled to the airframe 102, a pair of front inner wings 130-1 coupled to and extending from the airframe 102, and a pair of front wing rotors 150-1 coupled to the pair of front inner wings 130-1, a pair of rear inner wings 130-2 coupled to and extending from the airframe 102, and a pair of rear wing rotors 150-2 coupled to the pair of rear inner wings 130-2. The HSVTOL aircraft 100 may include additional equipment not shown in FIGS. 5-10 in some embodiments, such as, for example, a power source (e.g., a fuel source and/or one or more electrical batteries), and a computer-implemented onboard controller.

Similar to HSVTOL aircraft 10 shown in FIGS. 1-4, HSVTOL aircraft 100 is shiftable while airborne between a VTOL mode and a forward cruise mode shown in FIG. 1. In some embodiments, the HSVTOL aircraft 100 may have similar hover power as a conventional helicopter when in the VTOL mode. Additionally, in certain embodiments, the HSVTOL aircraft 100 may have a substantially greater lift to drag ratio in high-speed forward flight given the small frontal area of HSVTOL aircraft 100, enabling the HSVTOL aircraft 100 to sustain high forward speeds at substantially lower power than conventional helicopters.

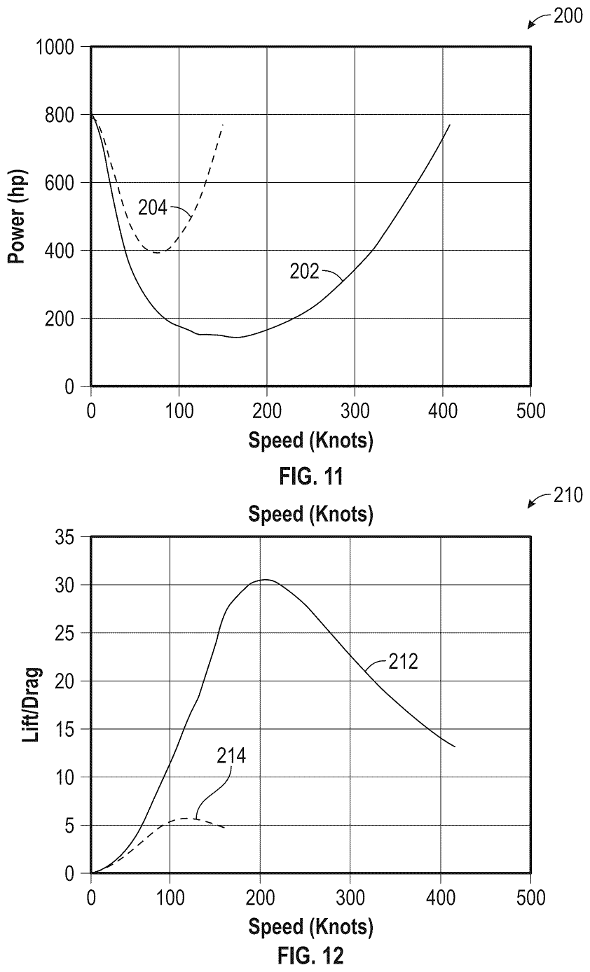

As an example, and referring briefly to FIGS. 11 and 12, graphs 200 and 210 are shown, respectively, illustrating exemplary performance characteristics of an embodiment of a HSVTOL aircraft (e.g., an embodiment similar to HSVTOL aircraft 100 shown in FIGS. 5-10) as compared to a conventional helicopter. Particularly, graph 200 illustrates power required to sustain a corresponding forward cruising speed for both a HSVTOL aircraft (indicated by curve 202) and a conventional helicopter (indicated by curve 204). As shown in graph 200, the HSVTOL aircraft provides a similar hover power as the conventional helicopter when in the VTOL mode while requiring a significantly lesser power for forward cruising when in the forward cruise mode. Moreover, the HSVTOL aircraft provides a maximum forward speed that is significantly greater than that provided by the conventional helicopter. Additionally, graph 210 illustrates a lift to drag ratio of different forward cruising speeds for both a HSVTOL aircraft (indicated by curve 212) and a conventional helicopter (indicated by curve 214). As shown in graph 210, when in the forward cruise mode, the HSVTOL aircraft has a significantly greater lift to drag ratio (e.g., five times greater in this example) than the conventional helicopter, providing the HSVTOL with significantly greater range than the conventional helicopter (e.g., three times the range of a conventional helicopter).

Returning to FIGS. 5-10, a base of each front wing rotor 150-1 is pivotably coupled to a terminal end of an accompanying front inner wing 130-1 via a front rotatory joint 140-1. Similarly, a base of each rear wing rotor 150-2 is pivotably coupled by to a terminal end of an accompanying rear inner wing 130-2 via a rear rotatory joint 140-2. Rotary joints 140 may comprise actuatable locking members shiftable between an unlocked state similar to the locking members 44 shown in FIGS. 1-3 to selectably permit rotation of front wing rotors 150-1 relative front inner wings 130-1 about front rotational axes 145-1 extending centrally through front rotary joints 140-1, and to selectably permit rotation of rear wing rotors 150-2 relative rear inner wings 130-2 about rear rotational axes 145-2 extending centrally through rear rotary joints 140-2.

In this exemplary embodiment, each front rotor wing 150-1 comprises an actuatable front rotor flap 152-1 extending along a trailing edge of the front rotor wing 150-1 and rotatable about a front flap axis. Similarly, each rear rotor wing 150-2 comprises an actuatable rear rotor flap 152-2 extending along a trailing edge of the rear rotor wing 150-2 and rotatable about a rear flap axis. In some embodiments, inner wings 130-1 and 130-2 may also comprise one or more actuatable flaps similar in configuration to rotor flaps 152-1 and 152-2, respectively. Additionally, in this exemplary embodiment, each rotor wing 150-1 and 150-2 comprises a counterweight 60 located at a base thereof and a tip jet 170-1 and 170-2, respectively located at a terminal end thereof. The counterweights 160 may, in some embodiments, be configured similarly as counterweights 60 shown in FIGS. 1-3. Additionally, tip jets 170-1 and 170-2 may, in certain embodiments, be configured similarly as tip jets 70 shown in FIGS. 1-3. Tip jets 170-1 and 170-2 may be fluidically connected with prime movers 120 to receive output gasses therefrom to generate rotational thrust by ejecting the output gasses at high velocity from a nozzle thereof.

In this exemplary embodiment, HSVTOL aircraft 100 has a length 101, a wingspan 103, and a disk diameter 105. Additionally, front wing rotors 150-1 have front disk areas 153-1 when rotating about their rotational axes 145-1 while rear wing rotors 150-2 have rear disk areas 153-2 when rotating about their rear rotational axes 145-2. The four separate disk areas 153-1 and 153-2 provided by wing rotors 150-1 and 150-2 may enable quadrotor-type control when in the VTOL mode, enhancing the stability and maneuverability of the HSVTOL aircraft 100 when in the VTOL mode.

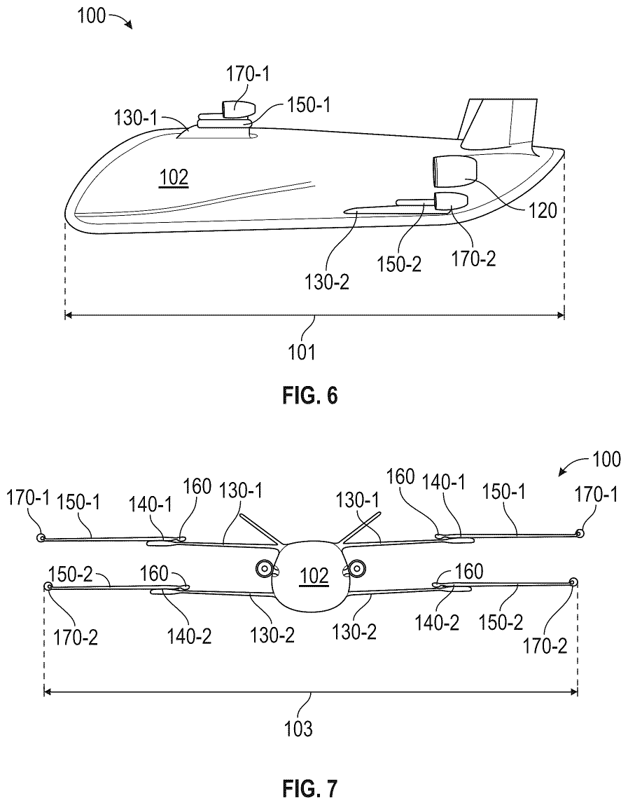

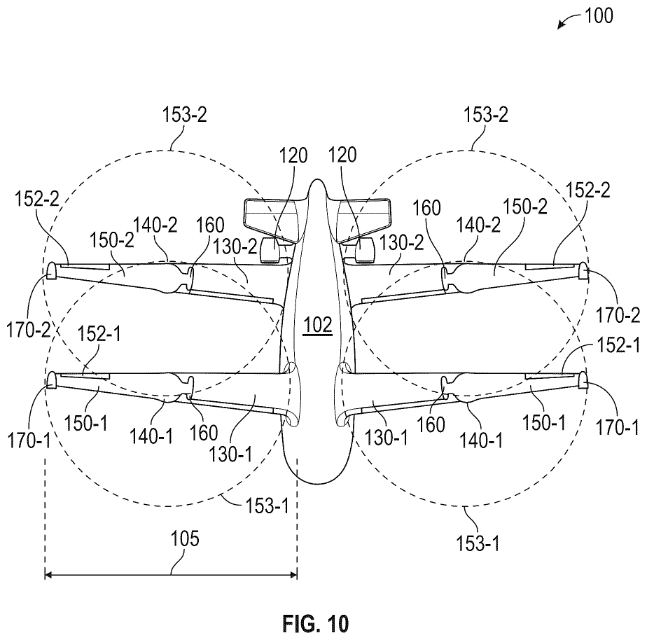

In this exemplary embodiment, front wing rotors 150-1 are vertically spaced from rear wing rotors 150-2 along the airframe 102 permitting the front disk areas 153-1 of front wing rotors 150-1 to vertically overlap (in a plan view of the HSVTOL aircraft 100) the disk areas 153-2 of rear wing rotors 150-2 as shown particularly in FIG. 10. Additionally, prime movers 120 may also be vertically spaced from both wing rotors 150-1 and 150-2 to provide an unobstructed flow of air to prime movers 120. By overlapping the disk areas 153-1 and 153-2 of wing rotors 150-1 and 150-2, the cumulative disk area of HSVTOL aircraft 100 may be maximized for its given footprint, maximizing its performance when in the VTOL mode. The disk loading of wing rotors 150-1 and 150-2 may also be desirably reduced due to their substantial disk area, with some embodiments having a disk loading of less than 15 pounds per foot squared. For example, with the “footprint” of the HSVTOL aircraft 100 defined as the product of the length (e.g., length 101 shown in FIG. 6) and the total wingspan (e.g., total wingspan 103 shown in FIG. 7), in some embodiments, a ratio of the cumulative disk area of HSVTOL aircraft 100 to the footprint of HSVTOL aircraft 100 is approximately between 0.7 and 0.9. Additionally, in certain embodiments, a ratio of the disk area of a single pair of wing rotors (e.g., the cumulative front disk area 153-1) to the total wingspan of HSVTOL aircraft 100 is approximately between 0.8 and 0.95. In other embodiments, the cumulative disk area of the HSVTOL may be increased by adding additional pairs of inner wings/wing rotors (e.g., three or more of such pairs).

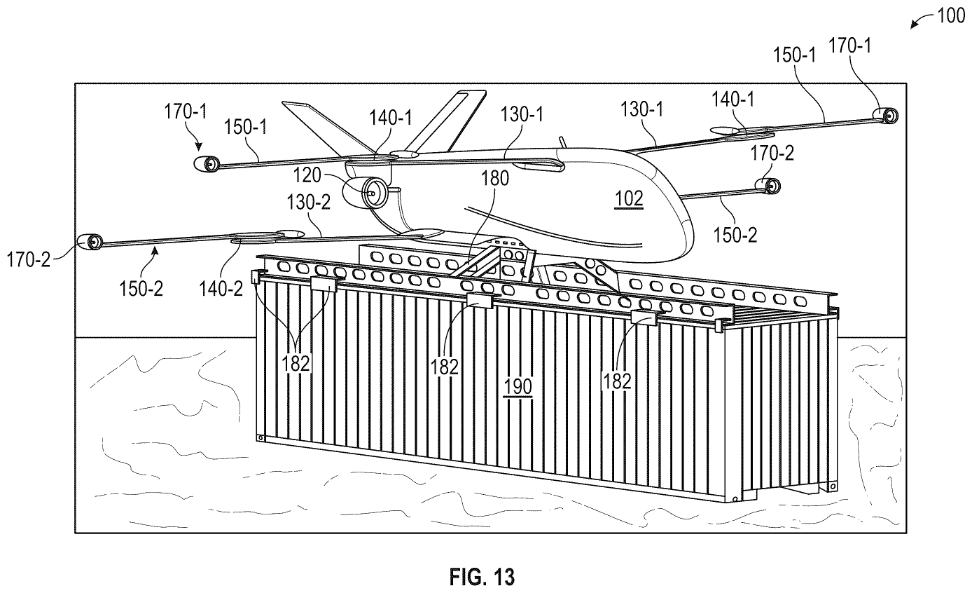

Referring to FIG. 13, an exemplary use case or application of the HSVTOL aircraft 100 is shown. In this example, HSVTOL aircraft 100 includes a payload mount 180 coupled to the airframe 102 thereof, where the payload mount 180 includes one or more releasable payload connectors 182 (e.g., electromechanical connectors such as grippers and the like) for releasably coupling to a payload 190. In this example, HSVTOL aircraft 100 may be launched from offshore platform such as a surface vessel and the like with payload 190 coupled to HSVTOL aircraft 100 via payload mount 180. Particularly, HSVTOL aircraft 100 may take-off vertically from the surface vessel in the VTOL mode and then shift in midair from the VTOL mode to the forward cruise mode.

The payload 190 transported by HSVTOL aircraft 100 may be relatively heavy given the energy efficiency and minimal weight of HSVTOL aircraft 100 with HSVTOL aircraft 100 not requiring any additional actuators for facilitating tilt rotor mechanisms and the like for shifting between forward cruise and VTOL modes. Moreover, with large distributed disk areas provided by wing rotors 150-1 and 150-2 when in the VTOL mode, the HSVTOL aircraft 100 is not sensitive to large variations in the location of the center of gravity (CG) thereof.

In the forward cruise mode, the HSVTOL aircraft 100 may transport the payload 190 at high speed (e.g., 100 or more knots, 200 or more knots 300 or more knots, 400 or more knots) from the location of the surface vessel to a distal target location such as an onshore facility. As the HSVTOL aircraft 100 approaches the target location, the HSVTOL may shift in midair from the forward cruise mode to the VTOL mode. The HSVTOL aircraft 100 may then descend vertically (with low speed lateral movement of HSVTOL aircraft 100 such as forward or reverse movement permitted) until landing at the target location. Upon landing, the payload 190 may be decoupled from payload mount 180 and HSVTOL may similarly return to the surface vessel in preparation for transporting another payload from the offshore vessel to the target location. This process may be repeated numerous times given the energy efficiency and maximal range offered by the HSVTOL aircraft 100.

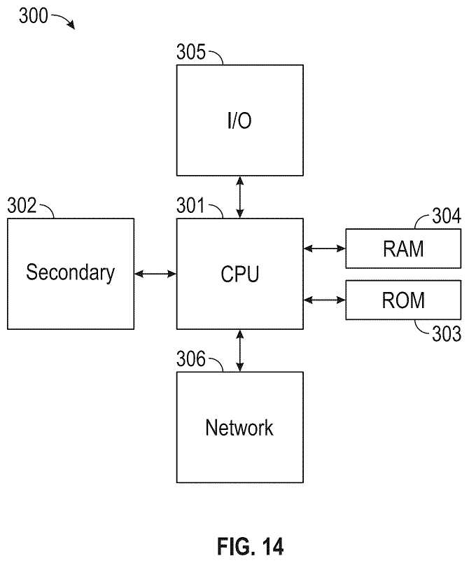

Any of the systems and methods disclosed herein can be carried out (e.g., entirely or partially) on a computer or other device comprising a processor (e.g., a desktop computer, a laptop computer, a tablet, a server, a smartphone, or some combination thereof). Referring now to FIG. 14, a computer system 300 suitable for implementing one or more embodiments disclosed herein (e.g., onboard controller 28 shown in FIGS. 1-3) is shown. The computer system 300 includes a processor 301 (which may be referred to as a central processor unit or CPU) that is in communication with memory devices including secondary storage 302, read only memory (ROM) 303, random access memory (RAM) 304, input/output (I/O) devices 305, and network connectivity devices 306. The processor 301 may be implemented as one or more CPU chips.

It is understood that by programming and/or loading executable instructions onto the computer system 300, at least one of the CPUs 301, the RAM 304, and the ROM 303 are changed, transforming the computer system 300 in part into a particular machine or apparatus having the novel functionality taught by the present disclosure. Thus, the RAM 304 and/or the ROM 303 may comprise a non-transitory machine-readable (or computer-readable) medium that may include instructions (which may be referred to herein as machine-readable instructions) that are executable by CPU 301 to provide functionality to computer system 300. Thus, in some embodiments, a machine-readable instructions stored on a memory may be executed on a processor, so as to configured the processor to carry out some or all of the features of the methods described herein.

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware (for example in an application specific integrated circuit (ASIC), or field-programmable gate arrays (FPGA)) because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the computer system 300 is turned on or booted, the CPU 301 may execute a computer program or application. For example, the CPU 301 may execute software or firmware stored in the ROM 303 or stored in the RAM 304. In some cases, on boot and/or when the application is initiated, the CPU 301 may copy the application or portions of the application from the secondary storage 302 to the RAM 304 or to memory space within the CPU 301 itself, and the CPU 301 may then execute instructions of which the application is comprised. In some cases, the CPU 301 may copy the application or portions of the application from memory accessed via the network connectivity devices 306 or via the I/O devices 305 to the RAM 304 or to memory space within the CPU 301, and the CPU 301 may then execute instructions of which the application is comprised. During execution, an application may load instructions into the CPU 301, for example load some of the instructions of the application into a cache of the CPU 301. In some contexts, an application that is executed may be said to configure the CPU 301 to do something, e.g., to configure the CPU 301 to perform the function or functions promoted by the subject application. When the CPU 301 is configured in this way by the application, the CPU 301 becomes a specific purpose computer or a specific purpose machine.

The secondary storage 302 is typically comprised of one or more disk drives or tape drives and is used for non-volatile storage of data and as an over-flow data storage device if RAM 304 is not large enough to hold all working data. Secondary storage 302 may be used to store programs which are loaded into RAM 304 when such programs are selected for execution. The ROM 303 is used to store instructions and perhaps data which are read during program execution. ROM 303 is a non-volatile memory device which typically has a small memory capacity relative to the larger memory capacity of secondary storage 302. The RAM 304 is used to store volatile data and perhaps to store instructions. Access to both ROM 303 and RAM 304 is typically faster than to secondary storage 302. The secondary storage 302, the RAM 304, and/or the ROM 303 may be referred to in some contexts as computer readable storage media and/or non-transitory computer readable media.

I/O devices 305 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 306 may take the form of modems, modem banks, Ethernet cards, Omni-Path Architecture (OPA), InfiniBand (IB), universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 306 may enable the processor 301 to communicate with the Internet or one or more intranets. With such a network connection, it is contemplated that the processor 301 might receive information from the network, or might output information to the network (e.g., to an event database) in the course of performing the methods described herein. Such information, which is often represented as a sequence of instructions to be executed using processor 301, may be received from and outputted to the network, for example, in the form of a computer data signal embodied in a carrier wave.

Such information, which may include data or instructions to be executed using processor 301 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 301 executes instructions, codes, computer programs, scripts which it accesses from hard disk, floppy disk, optical disk, solid state drives (SSD) (these various disk-based systems may all be considered secondary storage 302), flash drive, ROM 303, RAM 304, or the network connectivity devices 306. While only one processor 301 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 302, for example, hard drives, floppy disks, optical disks, and/or other device, the ROM 303, and/or the RAM 304 may be referred to in some contexts as non-transitory instructions and/or non-transitory information.

In an embodiment, the computer system 300 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 300 to provide the functionality of a number of servers that is not directly bound to the number of computers in the computer system 300. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 300, at least portions of the contents of the computer program product to the secondary storage 302, to the ROM 303, to the RAM 304, and/or to other non-volatile memory and volatile memory of the computer system 300. The processor 301 may process the executable instructions and/or data structures in part by directly accessing the computer program product, for example by reading from a CD-ROM disk inserted into a disk drive peripheral of the computer system 300. Alternatively, the processor 301 may process the executable instructions and/or data structures by remotely accessing the computer program product, for example by downloading the executable instructions and/or data structures from a remote server through the network connectivity devices 306. The computer program product may comprise instructions that promote the loading and/or copying of data, data structures, files, and/or executable instructions to the secondary storage 302, to the ROM 303, to the RAM 304, and/or to other non-volatile memory and volatile memory of the computer system 300.

In some contexts, the secondary storage 302, the ROM 303, and the RAM 304 may be referred to as a non-transitory computer readable medium or a computer readable storage media. A dynamic RAM embodiment of the RAM 304, likewise, may be referred to as a non-transitory computer readable medium in that while the dynamic RAM receives electrical power and is operated in accordance with its design, for example during a period of time during which the computer system 300 is turned on and operational, the dynamic RAM stores information that is written to it. Similarly, the processor 301 may comprise an internal RAM, an internal ROM, a cache memory, and/or other internal non-transitory storage blocks, sections, or components that may be referred to in some contexts as non-transitory computer readable media or computer readable storage media.

What is claimed is:

1. A high-speed vertical take-off and landing (HSVTOL) aircraft, comprising:
an airframe;
a pair of inner wings coupled to and extending from the airframe; and
a pair of wing rotors pivotably coupled to the pair of inner wings, wherein each of the pair of wing rotor has:
a rotatable configuration in which the wing rotor is freely rotatable entirely about a rotational axis of the wing rotor to generate vertically directed thrust that is applied to the airframe in a vertical take-off and landing (VTOL) mode of the HSVTOL aircraft; and
a fixed configuration in which the wing rotor is locked into a defined angular orientation about the rotational axis in a forward cruise mode of the HSVTOL aircraft.

2. The HSVTOL aircraft of claim 1, wherein the pair of wing rotors form at least a portion of a pair of fixed wings of the HSVTOL aircraft when in the forward cruise mode.

3. The HSVTOL aircraft of claim 2, wherein the HSVTOL aircraft includes a high-speed configuration when in the forward cruise mode in which the pair of wing rotors have a first sweep angle, and a low-speed configuration when in the forward cruise mode in which the pair of wing rotors have a second sweep angle that is different from the first sweep angle.

4. The HSVTOL aircraft of claim 2, wherein a sweep angle of the pair of wing rotors is adjustable when the HSVTOL aircraft is in the forward cruise mode.

5. The HSVTOL aircraft of claim 1, further comprising a locking member having an unlocked state permitting the free rotation of one or both of the pair of wing rotors about their rotational axes, and a locked state restricting rotation of one or both of the pair of wing rotors about their rotational axes.

6. The HSVTOL aircraft of claim 1, further comprising a prime mover separate from the pair of wing rotors and configured to drive rotation of one or both of the pair of wing rotors when the HSVTOL aircraft is in the VTOL mode.

7. The HSVTOL aircraft of claim 6, wherein the prime mover comprises a jet engine and at least one of the pair of wing rotors comprises a nozzle configured to receive a fluid flow from the jet engine to rotate the rotor about the rotational axis.

8. The HSVTOL aircraft of claim 1, wherein one or both of the pair of wing rotors comprises a single blade and a counterweight located diametrically opposite the single blade.

9. The HSVTOL aircraft of claim 1, wherein the pair of wing rotors each comprises an electric, ducted fan positioned at a tip thereof and a battery located opposite the fan to act as a counterweight.

10. The HSVTOL aircraft of claim 1, further comprising a pair of rotary actuators coupled to the airframe for driving the rotation of the pair of wing rotors about their rotational axes.

11. A high-speed vertical take-off and landing (HSVTOL) aircraft, comprising:
an airframe;
one or more prime movers coupled to the airframe and operable to generate forward thrust that is applied to the airframe during operation of the HSVTOL aircraft;
a pair of inner wings coupled to and extending from the airframe; and
a pair of wing rotors pivotably coupled to the pair of inner wings and powerable by the one or more prime movers to rotate each about a rotational axis of the wing rotor to generate a vertically directed thrust that is applied to the airframe during operation of the HSVTOL aircraft and which is separate from the forward thrust generated by the prime mover, and wherein both of the pair of wing rotors are lockable to the airframe during operation of the HSVTOL aircraft to restrict rotation of the rotor relative to the airframe.

12. The HSVTOL aircraft of claim 11, wherein the one or more prime movers comprises a jet engine and at least one of the pair of wing rotors comprises a nozzle configured to receive a fluid flow from the jet engine to rotate the wing rotor about the rotational axis.

13. The HSVTOL aircraft of claim 12, wherein the fluid flow comprises combustion products from the jet engine.

14. The HSVTOL aircraft of claim 11, wherein the one or more prime movers comprises a jet engine and at least one of the pair of wing rotors comprises a tip jet configured to receive a fluid flow from the jet engine to rotate the wing rotor about the rotational axis.

15. The HSVTOL aircraft of claim 11, further comprising a pair of rotary actuators coupled to the airframe for driving the rotation of the pair of wing rotors about their rotational axes.

16. A high-speed vertical take-off and landing (HSVTOL) aircraft, comprising:
an airframe;
a pair of inner wings coupled to and extending from the airframe; and
a pair of wing rotors pivotably coupled to the pair of inner wings and each rotatable about a rotational axis of the wing rotor to generate a vertically directed thrust that is applied to the airframe during operation of the HSVTOL aircraft, and wherein the pair of wing rotors are lockable to the airframe in a forward cruise mode of the HSVTOL aircraft to provide lift to generate lift.

17. The HSVTOL aircraft of claim 16, wherein the rotational axis of both of the pair of wing rotors remains fixed in orientation when the HSVTOL is in both the forward cruise mode and a vertical take-off and landing (VTOL) mode.

18. The HSVTOL aircraft of claim 16, further comprising a plurality of the pairs of wing rotors each rotatable about a separate rotational axis.

19. The HSVTOL aircraft of claim 18, wherein a first pair of the plurality pairs of wing rotors is vertically offset from a second pair of the plurality of pairs of wing rotors.

20. The HSVTOL aircraft of claim 16, further comprising a fixed wing extending from the airframe and having a terminal end defined by a terminal end of one of the pair of wing rotors.

21. The HSVTOL aircraft of claim 20, wherein the rotational axis of the one of the pair of wing rotors extends through both the wing rotor and the fixed wing.

22. The HSVTOL aircraft of claim 16, wherein at least one of the pair of wing rotors comprises an electric, ducted fan positioned at a tip thereof and a battery located opposite the fan to act as a counterweight.

23. The HSVTOL aircraft of claim 16, further comprising a pair of rotary actuators coupled to the airframe for driving the rotation of the pair of wing rotors about their rotational axes.
